(19) United States
(12) Patent Application Publication
(10) Pub. No.: US 2023/0278532 A1
(43) Pub. Date: Sep. 7, 2023

(54) BRAKE SYSTEM FOR MOTOR VEHICLE

(71) Applicant: ZF Active Safety GmbH, Koblenz (DE)

(72) Inventors: Karlheinz Schaust, Fachbach (DE); Georg Adams, Koblenz (DE); Zul Jalal Arif Ramli, Koblenz (DE); Stefan Sommer, Koblenz (DE); Casper Defesche, Noorbeek (NL)

(21) Appl. No.: 18/170,942

(22) Filed: Feb. 17, 2023

(30) Foreign Application Priority Data
Feb. 21, 2022 (DE) 102022103976.5

(51) Int. Cl. B60T 7/04; B60T 8/40

(52) U.S. Cl. CPC B60T 7/042; B60T 8/4081

(57) ABSTRACT

A brake system for a motor vehicle comprises an electronic control unit with a control circuit board a hydraulic block through which hydraulic channels extend and which has a brake cylinder bore a piston which is displaceable in the brake cylinder bore by a brake pedal, and a pedal travel sensor with a sensor circuit board. The pedal travel sensor is configured to detect the position of the piston in the brake cylinder bore. The brake system furthermore has a contact spring system that connects the control circuit board to the sensor circuit board, for transmission of signals, in non-destructively detachable fashion. Here, the contact spring system has electrical contact elements which bear in individually preloaded fashion against electrical contact pads of the control circuit board and/or of the sensor circuit board.

### CROSS-REFERENCE TO RELATED APPLICATION

This application claims priority to German Priority Application No. 102022103976.5, filed Feb. 21, 2022, the disclosure of which is incorporated herein by reference in its entirety.

### TECHNICAL FIELD

The disclosure relates to a brake system for a motor vehicle, comprising an electronic control unit with a control circuit board, comprising a hydraulic block through which hydraulic channels extend and which has a brake cylinder bore, comprising a piston which is displaceable in the brake cylinder bore by a brake pedal, and comprising a pedal travel sensor with a sensor circuit board. Here, the pedal travel sensor is configured to detect the position of the piston in the brake cylinder bore.

### BACKGROUND

Such brake systems are known from the prior art, for example under the abbreviation IBC for Integrated Brake Control.

In a brake system of said type, a hydraulic pressure is applied to wheel-side brake actuators of the motor vehicle in a manner dependent on the brake pedal position. Here, the brake pedal position is detected by the pedal travel sensor on the basis of the piston that is coupled to the brake pedal, which piston is mounted in displaceable fashion in the brake cylinder bore in the hydraulic block.

Since brake systems are safety-relevant devices of motor vehicles, the reliability thereof is subject to particularly stringent requirements.

At the same time, however, in particular in the motor vehicle manufacturing sector, there are high cost pressures that apply even to brake systems and the components thereof. It is also sought to design brake systems to be as simple and inexpensive as possible.

There is an obvious conflict of aims between these requirements, because inexpensive components are normally associated with a reduced level of reliability.

### SUMMARY

What is needed is to lessen or resolve this conflict of aims. It is thus sought to provide a brake system which is of simple and inexpensive construction, without need for compromises in terms of reliability.

A brake system for a motor vehicle is disclosed, comprising an electronic control unit with a control circuit board, comprising a hydraulic block through which hydraulic channels extend and which has a brake cylinder bore, comprising a piston which is displaceable in the brake cylinder bore by a brake pedal, and comprising a pedal travel sensor with a sensor circuit board. Here, the pedal travel sensor is configured to detect the position of the piston in the brake cylinder bore. The brake system furthermore has a contact spring system that connects the control circuit board to the sensor circuit board, for transmission of signals, in non-destructively detachable fashion. Here, the contact spring system has electrical contact elements which bear in individually preloaded fashion against electrical contact pads of the control circuit board and/or of the sensor circuit board.

It has been identified that tolerances relating to the arrangement of the control circuit board relative to the sensor circuit board can be compensated by the contact spring system. Here, the contact spring system is of simple design and, by virtue of the individually preloaded contact elements, reliably ensures that the control circuit board is connected to the sensor circuit board for transmission of signals. The brake system can thus be of inexpensive design.

In one exemplary arrangement, the contact spring system has a housing in which the contact elements are electrically isolated from one another in order to prevent a short circuit or disturbances in the transmission of signals. Furthermore, the contact elements can be mounted and arranged relative to one another in the housing to best effect. In this way, the contact spring system can be assembled with little effort, because the contact elements do not need to be individually installed; rather, it is possible for all contact elements to be jointly installed with the housing.

Here, the contact elements may project, by a projecting length, out of the housing in the direction of the associated contact pads, against which the contact elements bear in each case under preload. This has the advantage that axial tolerances, that is to say deviations in the spacing of the contact springs, which are assigned to one another and situated opposite one another, of the control circuit board and of the sensor circuit board can be reliably compensated.

It is furthermore possible here for the projecting length to be at least 2 mm, in one exemplary arrangement, at least 5 mm, in an unassembled state of the contact spring system, in order to provide a spring travel long enough that the contact elements can make bearing contact under preload in an effective manner, and can compensate even relatively large axial tolerances.

In a further exemplary arrangement, the contact elements each have a longitudinal axis. Furthermore, the contact elements are in this case arranged parallel to one another, and/or the longitudinal axes of the contact elements are perpendicular to the electrical contact pads, against which the contact elements bear in each case under preload. In this way, the construction and assembly of the contact spring system are further simplified, and good electrical contact between the contact elements and the associated contact pads is ensured.

In one exemplary arrangement, the contact elements are contact springs composed of electrically conductive material. Each contact element is thus configured as a single piece, and the brake system can be produced particularly inexpensively.

Furthermore, provision may be made here for the contact springs to each be elastically compressible along a longitudinal axis that is perpendicular to the electrical contact pad, against which the corresponding contact element bears under preload. This design has the advantage that electrical contact between the contact elements and the associated contact pads is ensured in a particularly reliable manner.

According to a further exemplary arrangement, the hydraulic block is a monolithic part and has a depression which is accessible from the outside and which extends in the direction of the brake cylinder bore and into which the pedal travel sensor is inserted, for example, in non-destructively removable fashion. In this way, the brake system can be assembled with little effort. Furthermore, owing to the depression, the pedal travel sensor is arranged close to the brake cylinder bore, such that the position of the piston and thus the pedal travel can be detected reliably.

Alternatively or in addition, in one exemplary arrangement, provision may be made for the pedal travel sensor to have a base, the inside of which is abutted by a sensor portion of the sensor circuit board, which is electrically connected via a connecting portion to a contacting portion of the sensor circuit board, which contacting portion is arranged on the top side of the pedal travel sensor. Here, the base is arranged close to the brake cylinder bore in order to effectively reduce the spacing between the sensor portion, which has the sensor of the sensor circuit board, and a signal transmitter, which is attached to the piston.

It is advantageous if the contact pads are circular in order to be able to reliably compensate radial tolerances, that is to say deviations transversely with respect to the centre of the contact pads or transversely with respect to the longitudinal axis of the contact elements. In other words, in this way, signal-transmitting contact can be ensured even if the contact elements are not aligned coaxially with respect to the centre of the contact pads.

### BRIEF DESCRIPTION OF DRAWINGS

Further features and advantages will emerge from the following description and from the appended drawings. In the drawings:

FIG. 1 shows a perspective sectional illustration of a brake system according to the an exemplary arrangement with a contact spring system, and

FIG. 2 shows, in a detail view, the contact spring system from FIG. 1 in a state in which a control circuit board of the brake system is arranged axially spaced apart from the contact spring system.

### DETAILED DESCRIPTION

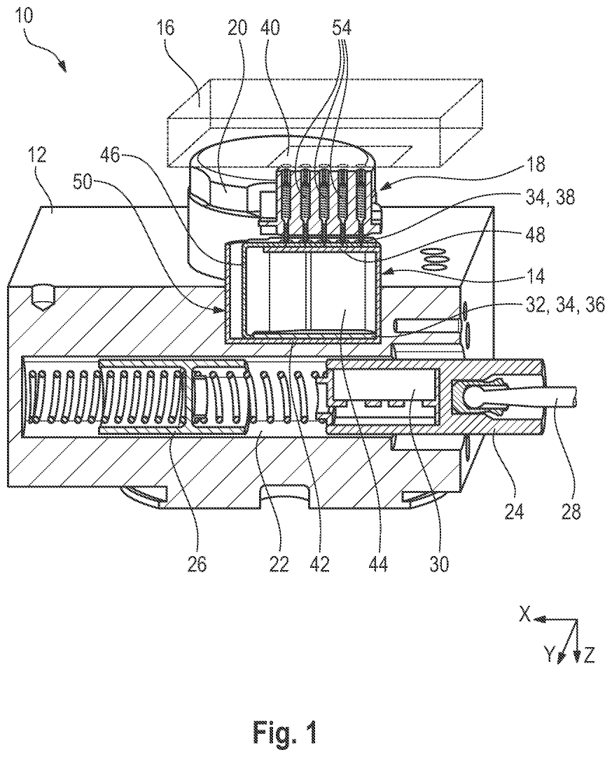

FIG. 1 shows a brake system 10 of IBC (Integrated Brake Control) type for a motor vehicle.

The brake system 10 has a hydraulic block 12 and a pedal travel sensor 14 and an electronic control unit 16 which are connected to one another, for transmission of signals, by a contact spring system 18.

Multiple hydraulic channels (not illustrated) extend through the hydraulic block 12, via which hydraulic channels a hydraulic pressure is applied by a pressure-generating unit 20 to brake actuators which are assigned to the brake system 10 and which are commonly in a wheel-side arrangement on the motor vehicle.

In the present exemplary arrangement, the hydraulic block 12 is of monolithic form.

In order to actuate the hydraulic block 12, said hydraulic block has a brake cylinder bore 22 in which a primary piston 24 and a secondary piston 26 of the brake system 10 are arranged.

Here, the primary piston 24 is coupled to a brake pedal 28 (of which only a portion of a coupling element is illustrated in FIG. 1) by which the primary piston 24 and the secondary piston 26 are displaceable in the brake cylinder bore 22.

In this way, a generation of pressure or a release of pressure can be selectively effected in pressure chambers that are assigned to the primary piston 24 and to the secondary piston 26.

In an alternative exemplary arrangement, the brake system 10 may self-evidently have a single piston instead of the piston system divided into the primary piston 24 and the secondary piston 26.

In order to detect the axial position of the primary piston 24 in the brake cylinder bore 22, the primary piston 24 has a signal transmitter 30 that is detected by an associated sensor 32 of the pedal travel sensor 14.

In this context, the pedal travel sensor 14 has a sensor circuit board 34 with a sensor portion 36, which comprises the sensor 32, and with a contacting portion 38, by which the sensor circuit board 34 is connected to a control circuit board 40 of the control unit 16, for transmission of signals, by the contact spring system 18, as will be discussed in more detail further below.

Here, the sensor portion 36 is arranged on a base 42, which forms a bottom side of the pedal travel sensor 14, in the interior 44 of the pedal travel sensor 14, and is electrically connected via a connecting portion 46 to the contacting portion 38, which is arranged on the outside on a top side 48, provided opposite the base 42, of the pedal travel sensor 14.

The connecting portion 46 is for example a flexible conductor portion or is formed by pins or cables.

The sensor 32 is for example a 3D hall sensor, whilst the signal transmitter 30 has one or more magnets.

In order to increase the signal quality and thus the measurement accuracy, the sensor 32 is arranged as close as possible to the brake cylinder bore 22. For this purpose, the hydraulic block 12 has a depression 50 for the pedal travel sensor 14, which depression extends into the hydraulic block 12, in the direction of the brake cylinder bore 22, from the outside.

Here, the depression 50 is configured such that the pedal travel sensor 14 can be inserted with the base 42 first into the depression 50, and can be removed from said depression again in the opposite direction, for example, without the pedal travel sensor 14 being destroyed or damaged in the process.

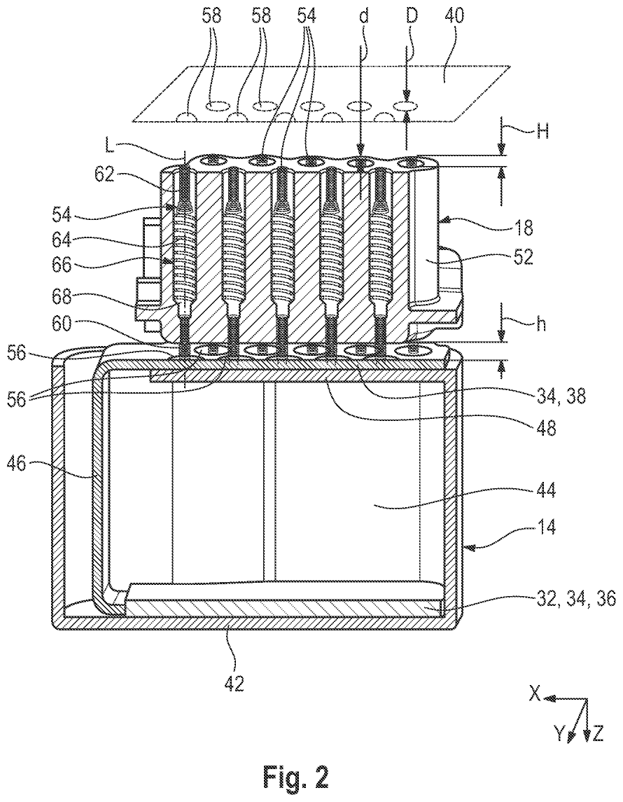

The electrical connection between the sensor circuit board 34 and the control circuit board 40, which is formed by the contact spring system 18, will be described below with reference to FIG. 2. Here, FIG. 2 shows the control circuit board 40 in a state in which the control circuit board 40 is spaced apart from the contact spring system 18 and is thus not bearing against the latter. In the assembled or operational state of the brake system 10 (see FIG. 1), the control circuit board 40 is however in contact with and electrically connected to the contact spring system 18.

The contact spring system 18 has a housing 52 and multiple electrical contact elements 54.

The contact elements 54 are configured to electrically connect in each case one electrical contact pad 56 of the sensor circuit board 34 to an associated electrical contact pad 58 of the control circuit board 40.

The number of contact elements 54 thus corresponds to the number of electrical contact pads 56 of the sensor circuit board 34 and to the number of electrical contact pads 58 of the control circuit board 40.

In the exemplary arrangement illustrated, the number is ten.

The contact elements 54 each extend along a longitudinal axis L and have a first contact portion 60 at one axial end, a second contact portion 62 at the opposite axial end, and a holding portion 64 that connects the first contact portion 60 to the second contact portion 62.

Furthermore, the contact elements 54 are formed from an electrically conductive material, for example copper.

In the present exemplary arrangement, each contact element 54 is a contact spring which is elastically compressible in an axial direction, that is to say in the direction of the longitudinal axis L.

In principle, the contact elements 54 may each be of any desired design, as long as they provide the functions discussed below.

For example, in an alternative exemplary arrangement, the first contact portion 60 and the second contact portion 62 may each be configured as a contact pin, and the holding portion 64 may be configured as an elastically compressible spring element.

Here, for each contact element 54, the housing 52 has a separate channel 66 as a receptacle, which channels extend all the way through the housing 52 in a vertical direction Z.

Furthermore, the housing 52 is formed from an electrically isolating material, for example a plastic, such that the contact elements 54 are received in the housing 52 so as to be electrically isolated from one another.

Here, the contact elements 54 extend along their longitudinal axis L in a vertical direction Z all the way through the housing 52, and project with the first contact portion 60 and the second contact portion 62 beyond the housing 52 in each case by a projecting length H in an axial direction when the contact spring system 18 has not been assembled, or when the first contact portion 60 and the second contact portion 62 are not bearing under preload against another component.

In the present exemplary arrangement, the projecting length H is equal for all contact portions 60, 62, and is 3 mm.

In an alternative exemplary arrangement, the projecting length H is at least 2 mm, in particular at least 5 mm.

Additionally or alternatively, the projecting lengths H of different contact elements 54, and/or the projecting lengths H of the first contact portion 60 and of the second contact portion 62 of individual contact elements 54, may differ from one another.

Here, the contact elements 54 are received in the channels 66 such that the contact elements 54 extend parallel to one another in a vertical direction Z through the housing 52.

Each channel 66 has a shoulder 68, against which the respective contact element 54 bears axially by way of its holding portion 64 and is thus fastened at least at one side in a longitudinal direction in the housing 52. In other words, the shoulder 68 forms an axial stop for the holding portion 64.

Here, the diameter of the holding portion 64 is greater than the diameter of the first contact portion 60.

In an alternative exemplary arrangement, each channel 66 may have a shoulder situated opposite the shoulder 68, such that the respective contact element 54 bears by way of its holding portion 64, at opposite ends, axially against the shoulder 68 and against the opposite shoulder and is thus fastened at both sides in a longitudinal direction in the housing 52.

In principle, it is not necessary for the contact elements 54 to be fastened in the housing 52 because, in the assembled state of the contact spring system 18, said contact elements are fastened radially in the housing 52 and axially between the sensor circuit board 34 and the control circuit board 40.

In order to simplify the assembly process, it is however advantageous for the contact elements 54 to be arranged captively, at least at one side, in the housing 52.

In an alternative exemplary arrangement, the contact elements 54 may, at the holding portion 64, be fastened in the channel 66 in any desired manner, for example in cohesive, non-positively locking and/or positively locking fashion, as long as the contact elements 54 remain axially elastically compressible.

In the assembled state, the contact spring system 18 is arranged between the sensor circuit board 34 and the control circuit board 40 in such a way that the contact elements 54 connect the contact pads 56 of the sensor circuit board 34 and the contact pads 58 of the control circuit board 40, which are situated opposite one another in pairs in a vertical direction Z, to one another for transmission of signals.

The housing 52 may in this case be attached to a housing of the control unit 16 and/or to a housing of the pedal travel sensor 14.

In the present exemplary arrangement, the contact pads 56 of the sensor circuit board 34 and the contact pads 58 of the control circuit board 40 extend in a horizontal plane, that is to say in a X-Y plane, and thus perpendicular to the longitudinal axis L of the contact elements 54.

Here, the spacing h between the housing 52 and the sensor circuit board 34 and between said housing and the control circuit board 40 is in each case smaller than the projecting length H, whereby the contact elements 54 are axially elastically compressed, and the contact portions 60, 62 bear in each case under preload against the associated contact pads 56, 58. In this way, axial tolerances in a vertical direction Z are compensated. In FIG. 2, the spacing h and the projecting length H are illustrated merely schematically and not to scale.

In order to compensate radial tolerances in the horizontal plane, the contact pads 56, 58 are circular and have a diameter D that is greater, for example by at least 50%, than the diameter d of the contact portions 60, 62 assigned to the contact pads 56, 58.

In an alternative exemplary arrangement, the contact elements 54 may make bearing contact under preload in each case at one contact portion 60, 62, for example by way of the first contact portions 60 against the contact pads 56 of the sensor circuit board 34, whilst the contact elements 54 are fastened at the respectively associated other contact portions 60, 62, for example by way of the second contact portions 60 to the contact pads 58 of the control circuit board 40.

In this way, it is ensured in the brake system 10 that the sensor circuit board 34 is connected to the control circuit board 40 for transmission of signals, and therefore the position of the primary piston 24 can be reliably taken into consideration by the control unit 16 in the control of the brake system 10.

The contact spring system 18, which is of simple design and which compensates both axial and radial tolerances in an effective manner, allows for the brake system 10 to be furthermore produced with little effort.

Furthermore, the contact elements 54 are elastically compressible independently of one another, whereby the contact portions 60, 62 bear in individually preloaded fashion against the contact pads 56, 58.

A further advantage is that the sensor circuit board 34 is connected in non-destructively detachable fashion to the control circuit board 40 by way of the contact elements 54.

The disclosure is not restricted to the exemplary arrangement shown. For example, individual features of an exemplary arrangement may be combined in any desired manner with features of other exemplary arrangement, independently of the other features of the corresponding exemplary arrangements.

1. A brake system for a motor vehicle, comprising an electronic control unit with a control circuit board, a hydraulic block through which hydraulic channels extend and which has a brake cylinder bore, a piston which is displaceable in the brake cylinder bore by a brake pedal, and a pedal travel sensor with a sensor circuit board, wherein the pedal travel sensor is configured to detect the position of the piston in the brake cylinder bore, wherein the brake system has a contact spring system that connects the control circuit board to the sensor circuit board, for transmission of signals, in a non-destructively detachable fashion, wherein the contact spring system electrical contact elements which bear in individually preloaded fashion against electrical contact pads of the control circuit board and/or of the sensor circuit board.

2. The brake system according to claim 1, wherein the contact spring system has a housing in which the contact elements are electrically isolated from one another.

3. The brake system according to claim 2, wherein the contact elements project, by a projecting length, out of the housing in a direction of the associated contact pads, against which the contact elements ear in each case under preload.

4. The brake system according to claim 3, wherein, in an uninstalled state of the contact spring system, the projecting length is at least 2 mm.

5. The brake system according to claim 1, wherein the contact elements each have a longitudinal axis, wherein the contact elements are arranged parallel to one another.

6. The brake system according to claim 1, wherein the contact elements are contact springs composed of electrically conductive material.

7. The brake system according to claim 6, wherein the contact springs are each elastically compressible along a longitudinal axis that is perpendicular to the electrical contact pad, against which the corresponding contact element bears under preload.

8. The brake system according to claim 1, wherein the hydraulic block is a monolithic part and has a depression which is accessible from the outside and which extends in the direction of the brake cylinder bore and into which the pedal travel sensor is inserted in a non-destructively removable fashion.

9. The brake system according to claim 1, wherein the pedal travel sensor has a base, the inside of which is abutted by a sensor portion of the sensor circuit board, which is electrically connected via a connecting portion to a contacting portion of the sensor circuit board, which contacting portion is arranged on a top side of the pedal travel sensor.

10. The brake system according to claim 1, wherein the contact pads are circular.

11. The brake system according to claim 3, wherein, in an uninstalled state of the contact spring system, the projecting length is at least 5 mm.

12. The brake system according to claim 3, wherein the contact elements each have a longitudinal axis, wherein the contact elements are perpendicular to the electrical contact pads, against which the contact elements bear in each case under preload.

13. The brake system according to claim 1, wherein the contact elements each have a longitudinal axis, wherein the contact elements are perpendicular to the electrical contact pads, against which the contact elements bear in each case under preload.

14. The brake system according to claim 3, wherein the contact elements each have a longitudinal axis, wherein the contact elements are arranged parallel to one another.

15. The brake system according to claim 3, wherein the contact elements are contact springs composed of electrically conductive material.

16. The brake system according to claim 3, wherein the hydraulic block is a monolithic part and has a depression which is accessible from the outside and which extends in the direction of the brake cylinder bore and into which the pedal travel sensor is inserted in a non-destructively removable fashion.

17. The brake system according to claim 1, wherein the pedal travel sensor has a base, the inside of which is abutted by a sensor portion of the sensor circuit board, which is electrically connected via a connecting portion to a contacting portion of the sensor circuit board, which contacting portion is arranged on a top side of the pedal travel sensor.
